(19) United States
(12) Patent Application Publication
(10) Pub. No.: US 2018/0312107 A1
(43) Pub. Date: Nov. 1, 2018

(54) FUNERAL SIGNALING DEVICE AND METHOD

(71) Applicants: Karen Perkins, Youngstown, OH (US); Michael A. McRae, Youngstown, OH (US)

(72) Inventors: Karen Perkins, Youngstown, OH (US); Michael A. McRae, Youngstown, OH (US)

(21) Appl. No.: 15/939,233

(22) Filed: Mar. 28, 2018

Related U.S. Application Data
(60) Provisional application No. 62/491,246, filed on Apr. 27, 2017.

(51) Int. Cl. B60Q 1/50; B60Q 1/26

(52) U.S. Cl. CPC B60Q 1/503; B60Q 2400/20; B60Q 1/2615; B60Q 1/2607

(57) ABSTRACT

A funeral signaling device includes a support stand having a support post and mounting magnet configured to magnetically couple the support stand to a vehicle. The device also includes a lighting assembly including a controller, power supply and light source, along with a flag indicating the presence of a funeral. The device is configured for removable coupling with a variety of vehicle types.

### CROSS-REFERENCE TO RELATED APPLICATION(S)

The present application is related to and claims priority to U.S. Provisional Patent Application No. 62/491,246 filed Apr. 27, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of signals and indicators of existing art and more specifically relates to vehicle indicators.

### RELATED ART

Funeral processions have the right of way on the road, are permitted to run red lights and other signs, and typically drive at a slower speed. Unfortunately, not all drivers are aware of these rules or even realize a funeral procession is underway. These drivers may cut off someone in a procession or collide into a vehicle in a procession, causing serious accidents, injuries, and possibly even death. While funeral flags are known in the art, these flags can often be difficult to mount or remove from a vehicle and may not be easily visible to other cars on the road. An effective alternative is needed.

U.S. Pat. No. 7,275,495 to Lawrence, et al. relates to a flagpole beacon. The described flagpole beacon includes an environmentally friendly beacon or light for illuminating a pole-mounted, halyard-hoisted flag, banner, pennant or the like that has a luminous source located in a cover, is mounted on top of the pole, and is capable of continuously directing a narrow beam of light toward the flag, banner, pennant or the like as the wind blows the same around the pole. There, the flagpole beacon is designed to replace the knob of an existing pole and may be used on poles having either an internal halyard configuration or an external halyard configuration.

### SUMMARY OF THE INVENTION

In view of the foregoing disadvantages inherent in the known signals and indicators art, the present disclosure provides a novel funeral signaling device and method. The general purpose of the present disclosure, which will be described subsequently in greater detail, is to provide a durable and portable funeral signaling device having a flag support, power supply, and self-contained lighting apparatus configured to clearly indicate the presence of a funeral procession.

A funeral signaling device is disclosed herein. The funeral signaling device may include a support stand including a base having a top and a bottom, a support post affixed to and extending above the base, and a mounting magnet affixed to a bottom of the base, and configured to magnetically couple the base to the vehicle, a lighting assembly including a power supply, a light source electrically coupled to the power supply, and a controller configured to selectably operate the light source, the lighting assembly mechanically coupled to the support post and configured to emit light outward from the funeral signaling device, and a flag including an indicia indicating a funeral, the flag mechanically coupled to the support post.

According to one embodiment, a method of using a funeral signaling device is also disclosed herein. The method of using a funeral signaling device may include providing the above funeral signaling device, activating the controller of the lighting assembly of the funeral signaling device, and mounting the funeral signaling device on an exterior surface of a vehicle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a funeral signaling device, constructed and operative according to the teachings of the present disclosure.

FIG. 1 is a perspective view of the funeral signaling device during an ‘in-use’ condition, according to an embodiment of the disclosure.

FIG. 2 is a perspective view of the funeral signaling device of FIG. 1, according to an embodiment of the present disclosure.

FIG. 3 is a front view of the funeral signaling device of FIG. 1, according to an embodiment of the present disclosure.

FIG. 4 is a top view of the funeral signaling device of FIG. 1, according to an embodiment of the present disclosure.

FIG. 5 is a flow diagram illustrating a method of using a funeral signaling device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a signals and indicators, and more particularly to a funeral signaling device as used to improve the visibility and clear designation of funeral processions. The funeral signaling device may include a support stand having a support post and mounting magnet configured to magnetically couple the support stand to a vehicle, a lighting assembly including a controller, power supply and light source, and a flag having indicia indicating the presence of a funeral. The device may be configured for removable coupling with a variety of vehicle types and provide a controllable light source that is helpful for drawing attention to the vehicle and funeral indicator.

Generally, the funeral signaling device includes a flashing light attached to a funeral flag for use during a funeral processional. The light may include a variety of flash settings, colors, and activation mechanisms. This device may help to increase the awareness of other drivers on the road aware to the funeral procession at hand, thereby providing the participating drivers with a respectful and peaceful journey.

This device may include an illuminated flagpole, including a power source, control unit, and LED lighting array with a protective housing. The array may be mounted on the tip of the flagpole with a tee connector, or other suitable means. Embodiments of the flagpole may vary, from full size stationary flagpoles to smaller temporary flagpoles that attach to vehicles via a magnet. Additionally, the flagpole can include an onboard on/off switch or remote control device that allow for additional customization of lighting frequency, flashing patterns, or duration. Included with the flagpole can be a pamphlet on processional etiquette to educate the public. The exact specifications may vary upon manufacturing.

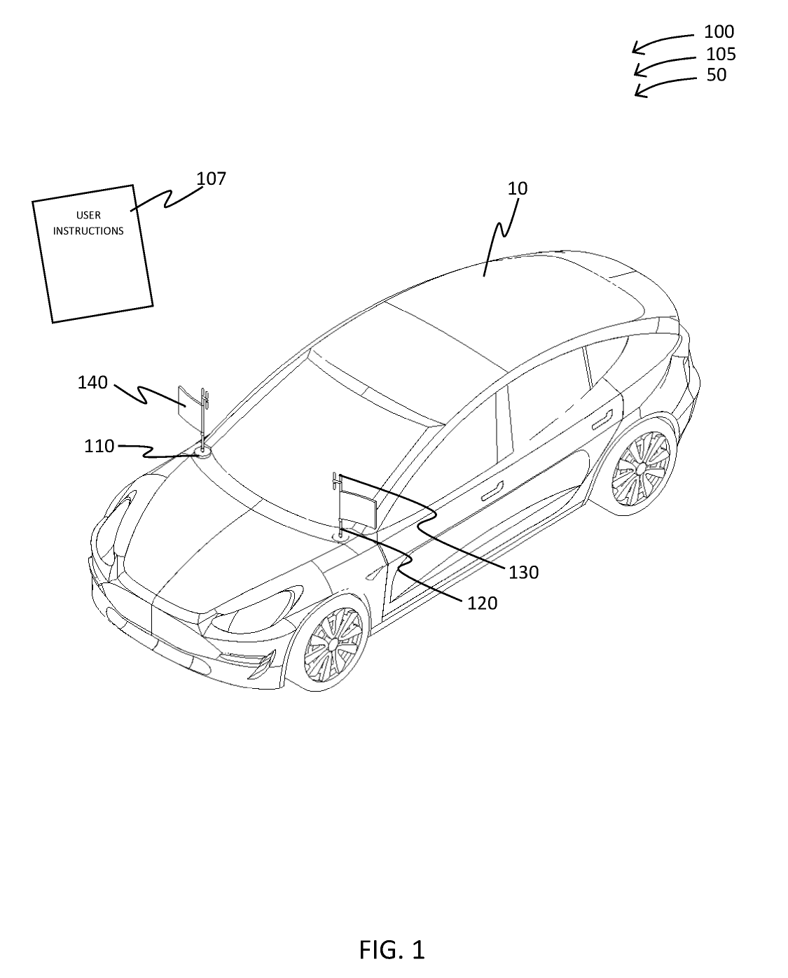

Referring now more specifically to the drawings by numerals of reference, there is shown in FIGS. 1-4, various views of a funeral signaling device 100.

FIG. 1 shows a funeral signaling device 100 during an ‘in-use’ condition 50, according to an embodiment of the present disclosure. Here, the funeral signaling device 100 may be beneficial for use by a user to improve the visibility and clear designation of funeral processions. As illustrated, the funeral signaling device 100 may include a support stand 110, a support post 120, a lighting assembly 130, and a flag 140, configured to mounting to a vehicle 10.

According to one embodiment, the funeral signaling device 100 may be arranged as a kit 105. In particular, the funeral signaling device 100 may further include a set of instructions 107. The instructions 107 may detail functional relationships in relation to the structure of the funeral signaling device 100 such that the funeral signaling device 100 can be used, maintained, or the like, in a preferred manner.

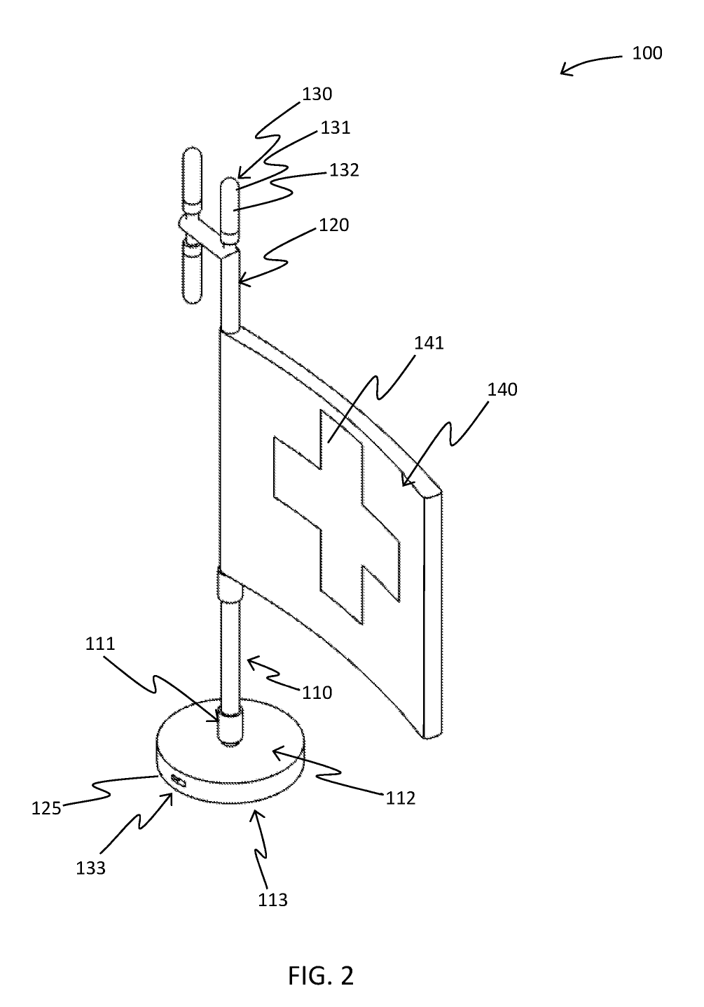

FIG. 2 shows the funeral signaling device 100 of FIG. 1, according to an embodiment of the present disclosure. As above, the funeral signaling device 100 may include a support stand 110 including a base 111 having a top 112 and a bottom 113, a support post 120 affixed to and extending upward from the base 111, and a mounting magnet 125 forming or otherwise affixed to a bottom 113 of the base 111, and configured to magnetically couple the base 111 to the vehicle 10 (FIG. 1).

The funeral signaling device 100 may further include a lighting assembly 130 including a power supply 131, a light source 132 electrically coupled to the power supply 131, and a controller 133 configured to selectably operate the light source 132. The lighting assembly 130 may be mechanically coupled to the support post 120 and configured to emit light outward from the funeral signaling device 100. The funeral signaling device 100 may also include a flag 140 including an indicia 141 indicating a funeral, for example, the indicia 141 may be in the form of a cross shape, as shown here. Further, the indicia 141 may be in the form of or otherwise include a written word, such as “Funeral”, “Procession”, or the like.

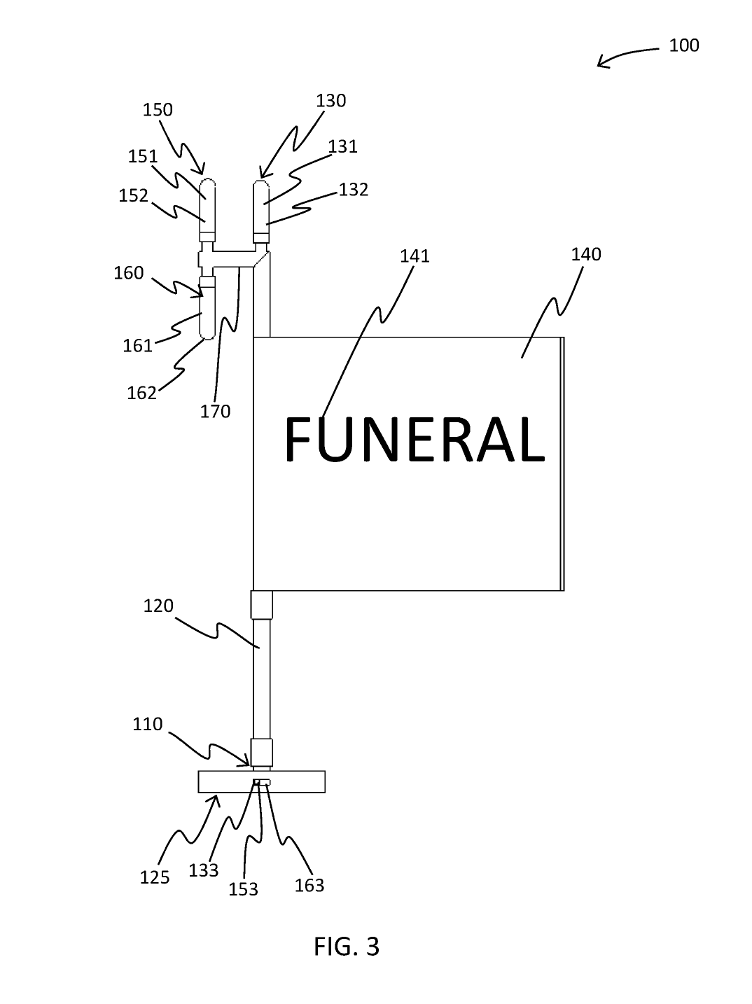

FIG. 3 is a front view of the funeral signaling device 100 of FIG. 1, according to an embodiment of the present disclosure. Here again, the funeral signaling device 100 may include a support stand 110, a mounting magnet 125, a support post 120 with a flag 140 coupled to the support post 120, and a lighting assembly 130 including a power supply 131, a light source 132. The power supply 131 may be embedded within the lighting assembly 130.

The funeral signaling device 100 may also include a first additional lighting assembly 150 that is substantially similar to the lighting assembly 130. The first additional lighting assembly 150 may include a first additional power supply 151, a first additional light source 152 electrically coupled to the first additional power supply 151, and a first additional controller 153 configured to selectably operate the first additional light source 152.

The funeral signaling device 100 may further include a second additional lighting assembly 160 that is substantially similar to the lighting assembly 130. The second additional lighting assembly 160 may include a second additional power supply 161, a second additional light source 162 electrically coupled to the second additional power supply 161, and a second additional controller 163 configured to selectably operate the second additional light source 162. According to one embodiment, the funeral signaling device 100 may include a light assembly coupling 170 affixed to the support stand 110 and configured to mechanically couple at least one of the lighting assembly 130, the first additional lighting assembly 150, and the second additional lighting assembly 160 to the support stand 110.

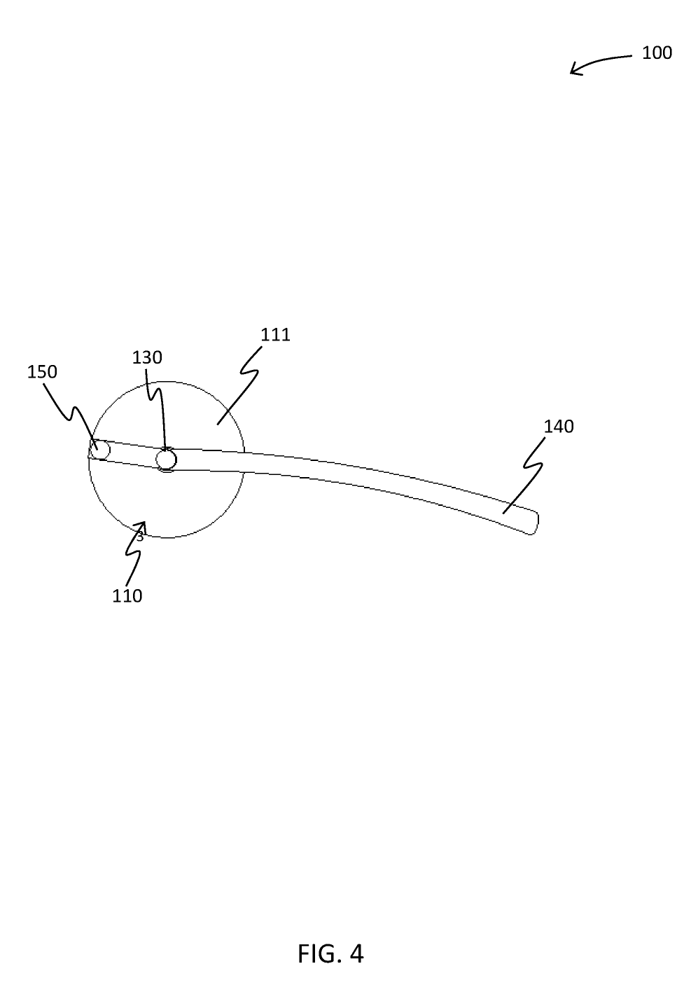

FIG. 4 is a top view of the funeral signaling device 100 of FIG. 1, according to an embodiment of the present disclosure. As above, the funeral signaling device 100 may include a support stand 110 including a base 111 and support post 120 (FIG. 1). The support post 120 may be configured to provide stability (and alternatively flexibility) for the flag 140. As shown, the funeral signaling device 100 may include the lighting assembly 130 and the first additional lighting assembly 150.

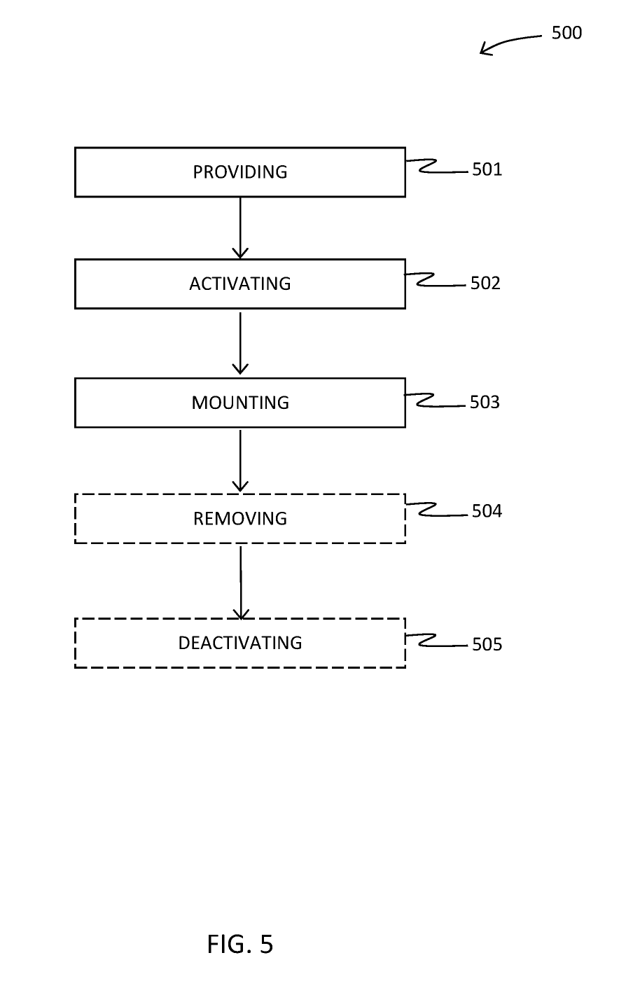

FIG. 5 is a flow diagram illustrating a method of using 500 a funeral signaling device 100, according to an embodiment of the present disclosure. In particular, the method of using 500 a funeral signaling device 100 may include one or more components or features of the funeral signaling device 100 as described above. As illustrated, the method of using 500 a funeral signaling device 100 may include the steps of: step one 501, providing the funeral signaling device 100 including the support stand 110 including the base 111 having the top 112 and the bottom 113, the support post 120 affixed to and extending upward from the base 111, the mounting magnet 125 affixed to a bottom 113 of the base 111, and configured to magnetically couple the base 111 to the vehicle 10, the lighting assembly 130 including the power supply 131, the light source 132 electrically coupled to the power supply 131, and the controller 133 configured to selectably operate the light source 132, the lighting assembly 130 mechanically coupled to the support post 120, and configured to emit light outward from the funeral signaling device 100, and a flag 140 including an indicia 141 indicating a funeral, the flag 140 mechanically coupled to the support post 120; step two 502, activating the controller 133 of the lighting assembly 130 of the funeral signaling device 100; and step three 503, mounting the funeral signaling device 100 on an exterior surface of a vehicle 10. According to one embodiment, the method 500 may further include step four 504, removing the funeral signaling device 100 from the exterior surface of the vehicle 10, and step five 505, deactivating the lighting assembly 130 of the funeral signaling device 100.

It should be noted that step four 504 and step five 505 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the funeral signaling device 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A funeral signaling device for a vehicle, the funeral signaling device comprising:
a support stand including a base having a top and a bottom, a support post affixed to and extending upward from the base, and a mounting magnet affixed to a bottom of the base, and configured to magnetically couple the base to the vehicle;
a lighting assembly including a power supply, a light source electrically coupled to the power supply, and a controller configured to selectably operate the light source, the lighting assembly mechanically coupled to the support post and configured to emit light outward from the funeral signaling device; and
a flag including an indicia indicating a funeral, the flag mechanically coupled to the support post.

2. The funeral signaling device of claim 1, wherein the support post of the support stand is configured to flex and resume a generally straight position.

3. The funeral signaling device of claim 1, wherein the mounting magnet has at least 5 pounds of magnetic coupling force.

4. The funeral signaling device of claim 1, wherein the light source includes a light bar.

5. The funeral signaling device of claim 1, wherein the light bar includes a plurality of LED lights aligned with the support post.

6. The funeral signaling device of claim 1, wherein the controller is configured to selectably blink the light source at a first blink-rate.

7. The funeral signaling device of claim 6, wherein the controller is further configured to selectably blink at the light source at a second blink-rate.

8. The funeral signaling device of claim 1, wherein the light source is configured to illuminate in a plurality of colors.

9. The funeral signaling device of claim 1, further comprising:
a first additional lighting assembly, the first additional lighting assembly including a first additional power supply, a first additional light source electrically coupled to the first additional power supply, and a first additional controller configured to selectably operate the first additional light source; and
a light assembly coupling affixed to the support stand and configured to mechanically couple the lighting assembly and the first additional lighting assembly to the support stand.

10. The funeral signaling device of claim 9, further comprising a second additional lighting assembly, the second additional lighting assembly including a second additional power supply, a second additional light source electrically coupled to the second additional power supply, and a second additional controller configured to selectably operate the second additional light source; and
wherein the light assembly coupling is further configured to mechanically couple the second additional lighting assembly to the support stand.

11. The funeral signaling device of claim 10, wherein the light source, the first additional light source, and the second additional light source are configured to illuminate in different colors; and
wherein the controller, the first additional controller, and second additional controller are combined in a single unit.

12. The funeral signaling device of claim 1, wherein the power supply includes at least one battery.

13. The funeral signaling device of claim 1, wherein the indicia indicating the funeral includes a cross shape.

14. The funeral signaling device of claim 1, wherein the indicia indicating the funeral includes a written word.

15. The funeral signaling device of claim 1, further comprising a light assembly coupling affixed to the support stand and configured to mechanically couple the lighting assembly to the support stand.

16. The funeral signaling device of claim 15, wherein light assembly coupling includes at least one zip-tie fastener.

17. A funeral signaling device for a vehicle, the funeral signaling device comprising:
a support stand including a base having a top and a bottom, a support post affixed to and extending above the base, and a mounting magnet affixed to a bottom of the base, and configured to magnetically couple the base to the vehicle;
a lighting assembly including a power supply, a light source electrically coupled to the power supply, and a controller configured to selectably operate the light source, the lighting assembly mechanically coupled to the support post and configured to emit light outward from the funeral signaling device;
a flag including an indicia indicating a funeral, the flag mechanically coupled to the support post;
a first additional lighting assembly, the first additional lighting assembly including a first additional power supply, a first additional light source electrically coupled to the first additional power supply, and a first additional controller configured to selectably operate the first additional light source;
a light assembly coupling affixed to the support stand and configured to mechanically couple the lighting assembly and the first additional lighting assembly to the support stand; and
a second additional lighting assembly, the second additional lighting assembly including a second additional power supply, a second additional light source electrically coupled to the second additional power supply, and a second additional controller configured to selectably operate the second additional light source; and
wherein the support post of the support stand is configured to flex and resume a generally straight position;
wherein the mounting magnet has at least 5 pounds of magnetic coupling force;
wherein the light source includes a light bar;
wherein the light bar includes a plurality of LED lights aligned with the support post;
wherein the controller is configured to selectably blink the light source at a first blink-rate;
wherein the controller is further configured to selectably blink at the light source at a second blink-rate;
wherein the light source is configured to illuminate in a plurality of colors;
wherein the light assembly coupling is further configured to mechanically couple the second additional lighting assembly to the support stand;
wherein the light source, the first additional light source, and the second additional light source are configured to illuminate in different colors;
wherein the controller, the first additional controller, and second additional controller are combined in a single unit;
wherein the power supply includes at least one battery;
wherein the indicia indicating the funeral includes a cross shape;
wherein the indicia indicating the funeral includes a written word; and
wherein light assembly coupling includes at least one zip-tie fastener.

18. The funeral signaling device of claim 17, further comprising set of instructions; and
wherein the device is arranged as a kit.

19. A method of using a funeral signaling device, the method comprising the steps of:
providing a funeral signaling device including
a support stand including a base having a top and a bottom, a support post affixed to and extending upward from the base, a mounting magnet affixed to a bottom of the base, and configured to magnetically couple the base to the vehicle,
a lighting assembly including a power supply, a light source electrically coupled to the power supply, and a controller configured to selectably operate the light source, the lighting assembly mechanically coupled to the support post, and configured to emit light outward from the funeral signaling device, and
a flag including an indicia indicating a funeral, the flag mechanically coupled to the support post;
activating the controller of the lighting assembly of the funeral signaling device; and
mounting the funeral signaling device on an exterior surface of a vehicle.

20. The method of claim 19, further comprising the steps of:
removing the funeral signaling device from the exterior surface of the vehicle; and
deactivating the lighting assembly of the funeral signaling device.
